(19) United States
(12) Patent Application Publication
(10) Pub. No.: US 2003/0046837 A1
(43) Pub. Date: Mar. 13, 2003

(54) Flame simulating assembly

(76) Inventor: Kristoffer Hess, Cambridge (CA)

Correspondence Address: Robert F. Delbridge, Gowling Lafleur Henderson LLP, Suite 1020, 50 Queen Street North, Kitchener, ON, N2H 6M2, CA

(21) Appl. No.: 09/968,796

(22) Filed: Oct. 3, 2001

(30) Foreign Application Priority Data
Sep. 12, 2001 (CA) 2,357,182

(51) Int. Cl. G09F 19/00

(52) U.S. Cl. 40/428

(57) ABSTRACT

The invention provides a flame simulating assembly having a simulated fuel bed, a light source, and a screen. The light source is operable to produce an image of flames appearing to be emitted from the simulated fuel bed. The screen has a front surface disposed behind the simulated fuel bed for transmitting the image of flames through the front surface. A pattern is included in the screen for simulating the appearance of firebrick to a viewer of the image of flames.

### FIELD OF THE INVENTION

This invention relates to flame simulating assemblies for use in electric or gas fireplaces and, in particular, a flame simulating assembly including a screen with a pattern on a front surface thereof.

### BACKGROUND OF THE INVENTION

A flame simulating assembly is disclosed in U.S. Pat. No. 6,050,011 (Hess et al.) in which silk-screened dots on a screen having a partially reflective front surface are positioned in relation to corresponding dots on an inside surface of a transparent front panel to create an illusion of a brick wall. However, in order for the illusionary brick effect to be successful, the inside surface disposed in front of the screen, through which inside surface an observer can view the screen, is required. As disclosed in U.S. Pat. No. 6,050,011, the inside surface of a generally transparent front panel of the flame simulating assembly can be utilized for this purpose.

In certain circumstances, however, an electric or gas fireplace does not include a transparent front panel. For example, where space constraints limit the depth of the electric or gas fireplace, the fireplace does not include a transparent front panel. Also, the additional elements required to achieve the illusionary brick effect disclosed in U.S. Pat. No. 6,050,011 result in somewhat increased manufacturing costs.

There is therefore a need for a flame simulating assembly which simulates the appearance of firebrick in a fireplace.

### SUMMARY OF THE INVENTION

In a broad aspect of the present invention, there is provided a flame simulating assembly having a simulated fuel bed, a light source, and a screen. The light source is operable to produce an image of flames appearing to be emitted from the simulated fuel bed. Also, the screen has a front surface disposed behind the simulated fuel bed for transmitting the image of flames through the front surface. The screen also includes a pattern for simulating the appearance of firebrick to a viewer of the image of flames.

### BRIEF DESCRIPTION OF THE DRAWINGS

The invention will be better understood with reference to the drawings, in which:

FIG. 1 is an isometric view of the preferred embodiment of a flame simulating assembly;

FIG. 2 is a front view of the flame simulating assembly of FIG. 1;

FIG. 3 is a section along line A-A in FIG. 2; and

FIG. 4 is a front view of another embodiment of the flame simulating assembly.

### BRIEF DESCRIPTION OF THE PREFERRED EMBODIMENT(S)

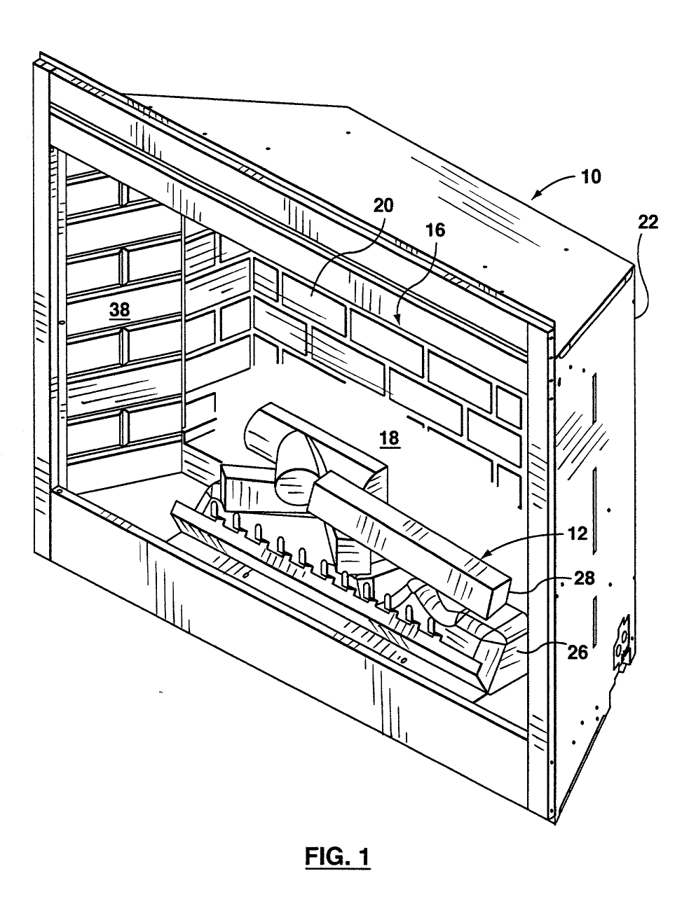

Reference is first made to FIG. 1 to describe a preferred embodiment of a flame simulating assembly indicated generally by the numeral 10 in accordance with the invention. As can be seen in FIGS. 1-3, the flame simulating assembly 10 includes a simulated fuel bed 12, a light source 14, and a screen 16. In the preferred embodiment, the light source 14 is operable to produce an image of flames appearing to be emitted from the simulated fuel bed 12. The screen 16 has a front surface 18 disposed behind the simulated fuel bed 12 for transmitting the image of flames through the front surface 18. In the preferred embodiment, the screen 16 includes a pattern 20 for simulating the appearance of firebrick to a viewer (not shown) of the image of flames.

As can be seen in FIGS. 1-3, the flame simulating assembly 10 includes a housing 22 to which the components comprising the flame simulating assembly 10 are directly or indirectly attached in any suitable manner. The preferred embodiment of the flame simulating assembly 10 could include a transparent panel in slot 23 positioned at the front of the housing 22.

Preferably, the front surface 18 is partially reflective, for reflecting an image of the simulated fuel bed 12. In addition, and as disclosed in U.S. Pat. Nos. 4,965,707, 5,642,580, and 6,050,011, the screen 16 includes a back surface or member 24 disposed behind the partially reflective front surface 18 for diffusing and transmitting light through the partially reflective front surface 18. Preferably, the pattern 20 is positioned in front of the back surface 24.

As disclosed in U.S. Pat. No. 4,965,707, the partially reflective front surface 18 can be constructed of glass or any other suitable material, such as acrylic or perspex, which is preferably lightly silvered. The back surface 24 may comprise a rear surface of the sheet of material which includes the partially reflective front surface, or a back member comprising, for example, a sheet of glass or any other suitable material which has been etched, abraded, frosted or otherwise created or treated so that it diffuses light transmitted through it.

Preferably, the pattern 20 is formed on the front surface 18. The pattern 20 can be painted or imprinted on the front surface 18 by any suitable method. For example, the pattern 20 could be screened, typographed, lithographed, engraved, or otherwise formed on the front surface 18. The pattern 20 could be formed using ink or paint or the like, and in color or, alternatively, in black and white. Preferably, the pattern 20 is formed on the front surface 18 with black and grey ink applied using silk screening. The pattern 20 is preferably formed to simulate the appearance of a wall of firebrick, and drawn or printed so that the pattern 20 gives the illusion of depth.

As indicated, the pattern 20 is formed to simulate the appearance of firebrick, a highly heat-resistant brick made from fire clay and used to line furnaces, chimneys, and fireplaces. Alternatively, the pattern 20 could be formed to simulate the appearance of any other suitable object or objects.

The simulated fuel bed 12 can be made of any suitable materials. Preferably, the simulated fuel bed 12 comprises a simulated ember bed 26 and a plurality of simulated fuel elements 28. It is preferred that the simulated ember bed 26 is formed to receive the simulated fuel elements 28, as described in Canadian Patent No. 2,310,362. FIGS. 1-3 show a plurality of simulated fuel elements 28 which are simulated logs of wood. Alternatively, the simulated fuel elements 28 could be formed and shaped to resemble lumps of coal (not shown).

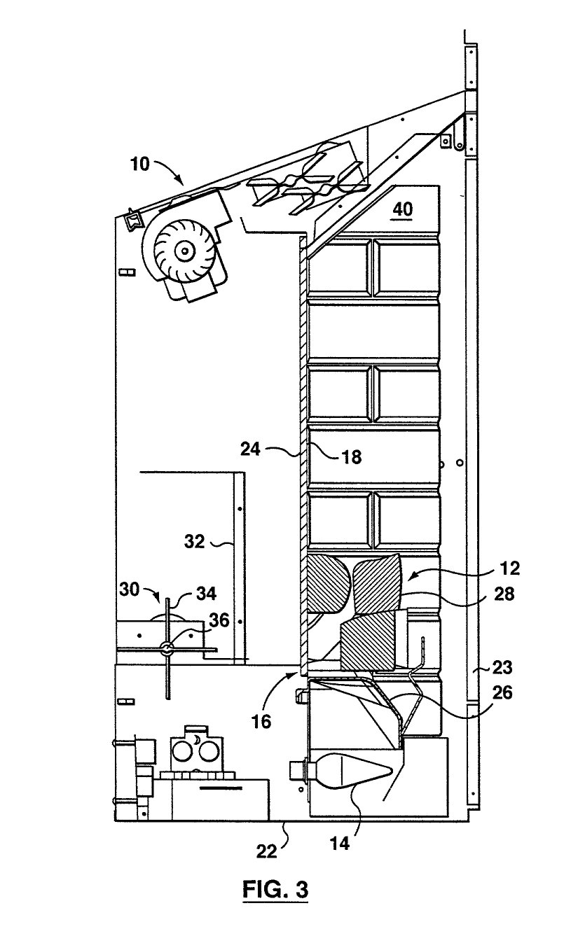

As can be seen in FIG. 3, the preferred embodiment of the flame simulating assembly 10 also includes a flicker element 30 and a flame effect element 32. The flicker element 30 is positioned in a path of light transmitted from the light source 14 to the back surface 24, for causing the light to flicker, to produce an image of flames. Preferably, and as disclosed in U.S. Pat. No. 5,642,580, the flicker element 30 comprises a plurality of strips 34 of substantially reflective material disposed around an axis 36 and extending radially outwardly from the axis 36. When the flame simulating assembly 10 is operating, the flicker element 30 is rotated about the axis 36 by any suitable means, such as a rotor (not shown).

In the preferred embodiment, the flame effect element 32 is preferably made of sheet metal or any other suitable material, as disclosed in U.S. Pat. No. 6,047,489. The flame effect element 32 is positioned in a path of flickering light from the light source 14 which has been reflected by the flicker element 30, to configure the flickering light. The flame effect element 32 configures the flickering light to produce an image of flames. Where the flame effect element 32 comprises a piece of sheet metal, a flame pattern is cut into the piece to provide one or more openings which configure the flickering light into an image of flames, so that the image of flames appears through the front surface 18. Other suitable arrangements could be made, for example, the flame effect element 32 could alternatively comprise a reflective surface (not shown) shaped and positioned so as to configure the flickering light into an image of flames.

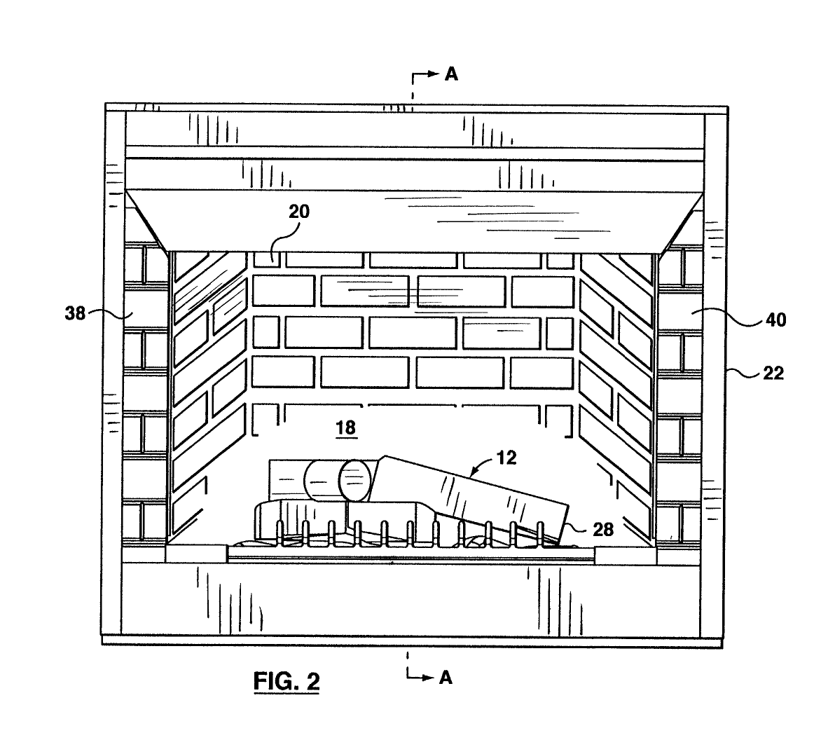

As can be seen in FIGS. 1-3, the preferred embodiment of the flame simulating assembly 10 also includes two panels 38, 40. FIG. 2 shows panels 38, 40 disposed in substantially vertical positions adjacent to vertical sides 41 of the front surface 18 between the screen 16 and the housing 22. Each of the panels 38, 40 is shaped and colored to simulate the appearance of the firebrick simulated by the pattern 20. Preferably, a sidewall pattern 42 is included on the panels 38, 40 which is so positioned that, when the panels 38,40 are in place, the sidewall pattern 42 is aligned with the pattern 20, thereby further providing an illusion of depth.

In use, in the preferred embodiment of the flame simulating assembly 10, light from the light source 14 is transmitted through the front surface 18 so that an image of flames appears through the front surface 18. The image of flames appears to be emitted from the simulated fuel bed 12. The pattern 20 provides an image of firebrick on, or transmitted through, the front surface 18, thereby achieving an improved simulation of a wood or coal fire in a real fireplace. The sidewall pattern 42 on the panels 38, 40 further enhances the overall simulation effect.

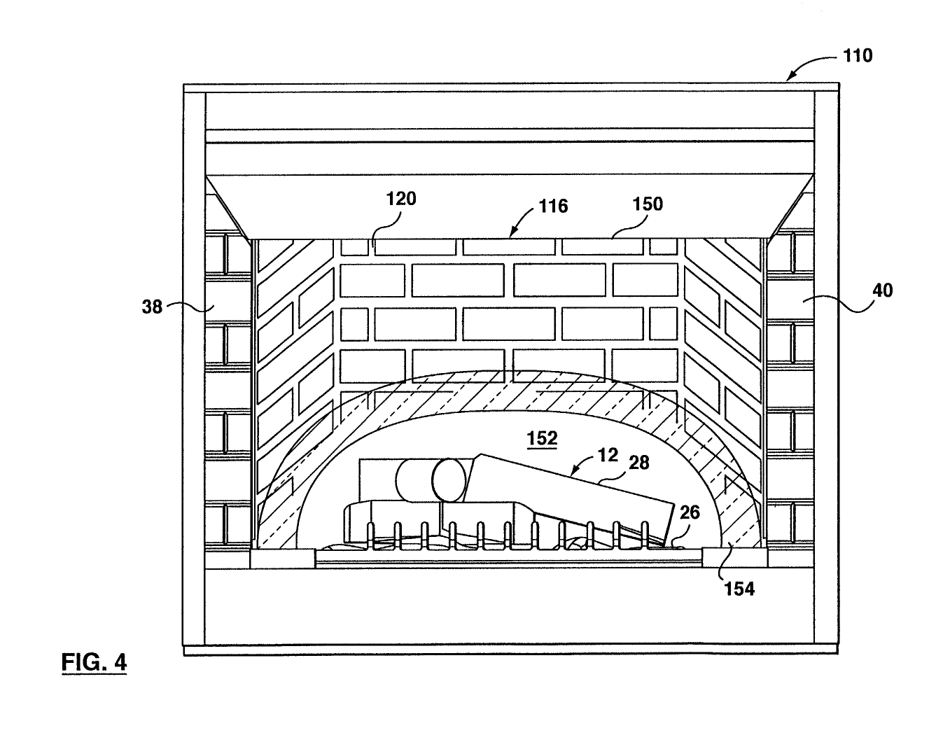

Another embodiment of the flame simulating assembly 110 is shown in FIG. 4. In FIG. 4, elements are numbered so as to correspond with like elements shown in FIGS. 1-3.

The flame simulating assembly 110 includes a screen 116 which includes a non-reflective matte region 150, a generally reflective region 152, and a transition region 154. As disclosed in U.S. Pat. No. 6,269,567, the generally reflective region 152 is positioned adjacent to the simulated fuel bed 12, and at least partially reflects the simulated fuel bed 12. The non-reflective matte region 150 is positioned distal to the simulated fuel bed 12, and transmits the image of flames. The transition region 154 is positioned between the non-reflective matte region 150 and the generally reflective region 152.

In the flame simulating assembly 110, a pattern 120 is preferably positioned substantially in the non-reflective matte region 150, and also extending into the transition region 154. Preferably, and as shown in FIG. 4, the pattern 120 simulates the appearance of firebrick. The simulation effect achieved with the pattern 120 is somewhat enhanced due to the pattern 120 being used in combination with the non-reflective matte region 150 and the transition region 154, as shown in FIG. 4, and as described. Alternatively, the pattern 120 could simulate the appearance of any suitable object or objects.

The above-described embodiments of the present invention are intended to be examples only. Alterations, modifications and variations may be effected to the particular embodiments by those skilled in the art without departing from the scope of the invention, which is defined solely by the claims appended hereto.

I claim:

1. A flame simulating assembly having:
(a) a simulated fuel bed;
(b) a light source operable to produce an image of flames appearing to be emitted from the simulated fuel bed; and
(c) a screen having a front surface disposed behind the simulated fuel bed for transmitting the image of flames through the front surface, the screen including a pattern for simulating the appearance of firebrick to a viewer of the image of flames.

2. A flame simulating assembly according to claim 1 in which the front surface is partially reflective for reflecting an image of the simulated fuel bed, the screen includes a back surface disposed behind the partially reflective front surface for diffusing and transmitting light through the partially reflective front surface, and the pattern is positioned in front of the back surface.

3. A flame simulating assembly according to claim 2 in which the partially reflective front surface has a substantially non-reflective matte region, the non-reflective matte region being disposed distal from the simulated fuel bed, and the portion of the front surface not covered by the non-reflective matte region being a generally reflective region, such that the simulated fuel bed is substantially the only object reflected in the front surface, wherein light from the light source is transmitted through the front surface.

4. A flame simulating assembly according to claim 3 wherein the front surface further includes a transition region which is partially reflective and partially non-reflective, the transition region being disposed between the non-reflective matte region and the reflective region.

5. A flame simulating assembly according to claim 1 additionally including at least one panel positioned adjacent to the screen, the panel having a sidewall pattern formed thereon for simulating the appearance of firebrick.

6. A flame simulating assembly having:
(a) a simulated fuel bed;
(b) a light source;
(c) a screen having a partially reflective front surface disposed behind the simulated fuel bed for reflecting and transmitting light, and a diffusing back surface disposed behind the partially reflective front surface for diffusing and transmitting light;
(d) a flicker element positioned in a path of light transmitted from the light source to the diffusing back surface to produce an image of flames; and
(e) the partially reflective front surface having a substantially non-reflective matte region, the non-reflective matte region being disposed distal from the simulated fuel bed, and the portion of the front surface not covered by the non-reflective matte region being a generally reflective region, such that the simulated fuel bed is substantially the only object reflected in the front surface, and the screen including a pattern simulating the appearance of firebrick,
wherein light from the light source is transmitted through the front surface such that the image of flames appears through the front surface.

7. A flame simulating assembly according to claim 6 wherein the front surface further includes transition region which is partially reflective and partially non-reflective, the transition region being disposed between the non-reflective matte region and the reflective region.

8. A flame simulating assembly according to claim 7 in which the pattern is positioned substantially in the non-reflective matte region and extending into the transition region.

9. A flame simulating assembly having:
(a) a simulated fuel bed;
(b) a light source;
(c) a screen having a partially reflective front surface disposed behind the simulated fuel bed for reflecting and transmitting light, and a diffusing back surface disposed behind the partially reflective front surface for diffusing and transmitting light;
(d) a flicker element positioned in a path of light transmitted from the light source to the diffusing back surface;
(e) a flame effect element positioned in the path of light, for configuring light to produce an image of flames; and
(f) the partially reflective front surface having a substantially non-reflective matte region, the non-reflective matte region being disposed distal from the simulated fuel bed, and the portion of the front surface not covered by the non-reflective matte region being a generally reflective region, such that the simulated fuel bed is substantially the only object reflected in the front surface, and the screen including a pattern simulating the appearance of firebrick,
wherein light from the light source is transmitted through the front surface such that the image of flames appears through the front surface.

10. A flame simulating assembly according to claim 9 wherein the front surface further includes a transition region which is partially reflective and partially non-reflective, the transition region being disposed between the non-reflective matte region and the reflective region.

11. A flame simulating assembly according to claim 10 in which the pattern is positioned substantially in the non-reflective matte region and extending into the transition region.
